(19) United States
(12) Patent Application Publication
(10) Pub. No.: US 2018/0328282 A1
(43) Pub. Date: Nov. 15, 2018

(54) EXHAUST SECTION FOR AN AIRCRAFT GAS TURBINE ENGINE

(71) Applicant: GE Aviation Systems LLC, Grand Rapids, MI (US)

(72) Inventor: Michel ENGELHARDT, Woodbury, NY (US)

(21) Appl. No.: 15/527,886

(22) PCT Filed: Nov. 21, 2014
(86) PCT No.: PCT/US2014/066959

§ 371 Date: May 18, 2017

(51) Int. Cl. F02C 6/18; F01D 9/02; F01D 15/10; B64D 41/00; H02K 44/08; H02K 44/10

(52) U.S. Cl. CPC F02C 6/18; F01D 9/02; F01D 15/10; B64D 41/00; F05D 2220/60; H02K 44/10; F05D 2220/323; F05D 2260/408; H02K 44/085

(57) ABSTRACT

An exhaust section for an aircraft gas turbine engine includes an exhaust nozzle in a downstream serial flow relationship with the gas turbine engine having a fan section, a compressor section, a combustion section, a turbine section, and an exhaust section. The compressor section compresses intake air from the fan section, which is mixed with fuel and combusted into hot gases in the combustion section. The hot gases drive the turbines of the turbine section, and are expelled from the gas turbine engine at the exhaust section.

### CROSS REFERENCE TO RELATED APPLICATION

This application is a continuation-in-part of International Application No. PCT/US2013/71951, filed Nov. 26, 2013, and is incorporated herein by reference.

### BACKGROUND OF THE INVENTION

Turbine engines, and particularly gas turbine engines, also known as combustion turbine engines, are rotary engines that extract energy from a flow of combusted gases passing through the engine onto a multitude of turbine blades. Gas turbine engines have been used for land and nautical locomotion and power generation, but are most commonly used for aeronautical applications such as for airplanes, including helicopters. In aircraft, gas turbine engines are used for propulsion of the aircraft.

Gas turbine engines also usually provide power for a number of different accessories such as generators, starter/generators, permanent magnet alternators (PMA), fuel pumps, and hydraulic pumps, e.g., equipment for functions needed on an aircraft other than propulsion. In aircraft, gas turbine engines typically provide mechanical power which a generator will convert into electrical energy needed to power accessories.

### BRIEF DESCRIPTION OF THE INVENTION

An exhaust section for an aircraft gas turbine engine, includes an exhaust nozzle in a downstream serial flow relationship with the gas turbine engine, and defining an exhaust cavity through which combustion exhaust gases of the engine are emitted in a direction defining an exhaust vector, and a magnetohydrodynamic (MHD) generator having a magnetic field generator forming a magnetic field having at least some magnetic field lines perpendicular to the exhaust vector, and at least one electrically coupled electrode pair, comprising at least one positive electrode and at least one negative electrode, arranged relative to the exhaust cavity wherein movement of charged particles entrained in the exhaust gas along the exhaust vector generates current between the at least one electrode pair. The conversion of exhaust gas enthalpy into electric current by the MHD generator increases the propulsion efficiency of the gas turbine engine by reducing the exhaust gas temperature.

### BRIEF DESCRIPTION OF THE DRAWINGS

In the drawings:

FIG. 1 is a schematic cross-sectional diagram of a gas turbine engine for an aircraft having a magnetohydrodynamic generator, in accordance with the first embodiment of the invention.

FIG. 2 is a partial sectional view taken along line 2-2 of FIG. 1 showing the axial assembly of the magnetohydrodynamic generator, in accordance with the first embodiment of the invention.

FIG. 3 is a schematic view illustrating the magnetic field lines and particle flow relative to the electrode location of the magnetohydrodynamic generator, in accordance with the first embodiment of the invention.

FIG. 4 is a schematic view illustrating the magnetic field lines and particle flow relative to the electrode location of the magnetohydrodynamic generator, in accordance with the second embodiment of the invention.

FIG. 5 is a schematic view illustrating the magnetic field lines and particle flow relative to the electrode location of the magnetohydrodynamic generator, in accordance with the third embodiment of the invention.

FIG. 6 is a schematic view illustrating the magnetic field lines and particle flow relative to the electrode location of the magnetohydrodynamic generator, in accordance with the fourth embodiment of the invention.

FIG. 7 is a schematic view illustrating the magnetic field lines and particle flow relative to the electrode location of the magnetohydrodynamic generator, in accordance with the fifth embodiment of the invention.

### DESCRIPTION OF EMBODIMENTS OF THE INVENTION

The described embodiments of the present invention are directed to power extraction from an aircraft engine, and more particularly to an electrical power system architecture which enables production of electrical power from a turbine engine, preferably a gas turbine engine. It will be understood, however, that the invention is not so limited and has general application to electrical power system architectures in non-aircraft applications, such as other mobile applications and non-mobile industrial, commercial, and residential applications.

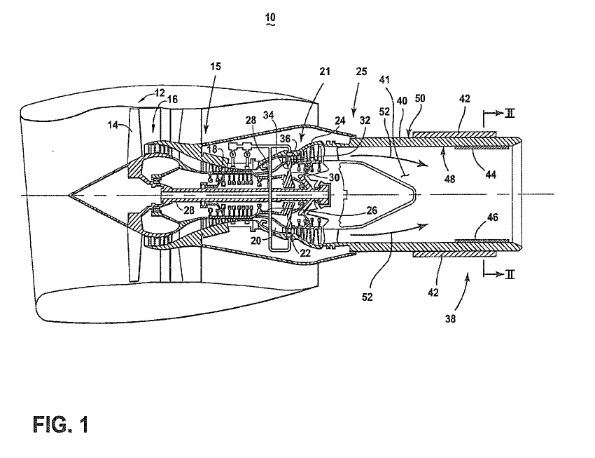

FIG. 1 is a schematic cross-sectional diagram of a gas turbine engine 10 for an aircraft with a magnetohydrodynamic (MHD) generator 38. The engine 10 includes, in downstream serial flow relationship, a fan section 12, a compressor section 15, a combustion section 20, a turbine section 21, and an exhaust section 25. The fan section 12 includes a fan 14, and the compressor section 15 includes a booster or low pressure (LP) compressor 16, a high pressure (HP) compressor 18. The turbine section 21 comprises a HP turbine 22, and a LP turbine 24. The engine 10 may further include a HP shaft or spool 26 that drivingly connects the HP turbine 22 to the HP compressor 18 and a LP shaft or spool 28 that drivingly connects the LP turbine 24 to the LP compressor 16 and the fan 14. The HP turbine 22 includes an HP turbine rotor 30 having turbine blades 32 mounted at a periphery of the rotor 30. Blades 32 extend radially outwardly from blade platforms 34 to radially outer blade tips 36.

The exhaust section 25 may include an exhaust nozzle 40, which may further comprise an inner surface 48 and an outer surface 50, and the MHD generator 38. The inner surface 48 of the exhaust nozzle 40 defines an exhaust cavity 41. The MHD generator includes a magnetic field generating apparatus, for example, at least one energizable solenoid 42, electromagnet, or permanent magnet, and at least one positive electrode 44 and at least one negative electrode 46, defining an electrode pair. As shown, the solenoids 42 may be operably supported by and/or coupled with the outer surface 50 of the exhaust nozzle 40, while the electrodes 44, 46 may be operably supported by and/or coupled with the inner surface 48 of the nozzle 40. The electrodes 44, 46 are configured along the axial length of the exhaust nozzle 40, and shown positioned near the downstream rear of the nozzle 40. Alternative configurations are envisioned wherein any combination of the solenoids 42 and/or the electrodes 44, 46 are supported by and/or coupled with either the inner or outer surfaces 48, 50 of the exhaust nozzle 40. Other alternative configurations are envisioned; wherein, the solenoid 42 and/or the electrodes 44, 46 are supported by and/or coupled with alternative structural elements.

The gas turbine engine 10 operates such that the rotation of the fan 14 draws air into the HP compressor 18, which compresses the air and delivers the compressed air to the combustion section 20. In the combustion section 20, the compressed air is mixed with fuel, which for example, may include charged particles, and the air/fuel mixture is ignited, expanding and generating high temperature exhaust gases. The engine exhaust gases, which may still include the charged particles, traverse downstream, passing through the HP and LP turbines 22, 24, generating the mechanical force for driving the respective HP and LP spools 26, 28, where the exhaust gases, for example, of the internal exhaust plume, are finally expelled from the rear of the engine 10 into the exhaust cavity 41, in the direction indicated by an exhaust vector 52. As shown, the exhaust nozzle 40, exhaust cavity 41, and exhaust vector 52 may extend along a substantially similar axial direction, in a downstream serial flow relationship with an internal engine exhaust plume. In addition, charged particles may alternatively or additionally be introduced into the exhaust cavity 41 by, alternative components, for example, an inlet of a spray nozzle, exhaust ring, or the exhaust nozzle 40 outlet, fluidly coupled with a charged particle reservoir, or reservoir outlet. In this example, the charged particles may be controllably introduced to the exhaust cavity 41 by, for example, a controllable valve of the reservoir, nozzle, ring, and/or fluid coupling.

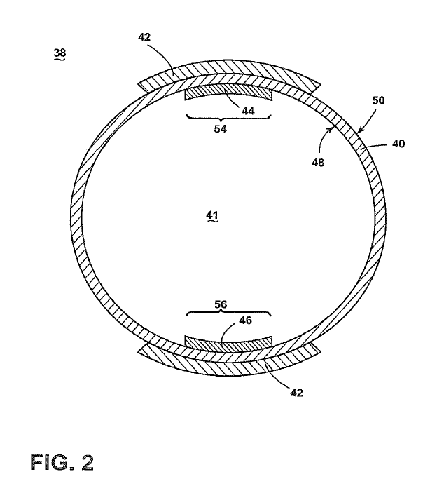

FIG. 2 illustrates the MHD generator 38 from an axial perspective along the exhaust nozzle 40. As shown, the positive electrode 44 extends along at least a portion of a first radial segment 54 of the exhaust nozzle 40 and the negative electrode 46 extends along at least a portion of a second radial segment 56 of the nozzle 40. Additionally, while electrodes 44, 46 are shown located on vertically-aligned, opposing sides of each other 44, 46, relative to the exhaust cavity 41, alternative configurations are envisioned wherein the opposing electrodes 44, 46 are aligned or offset from either a vertical or horizontal axis. Embodiments of the invention are also envisioned wherein the solenoids 42 are aligned or offset from either a vertical or horizontal axis.

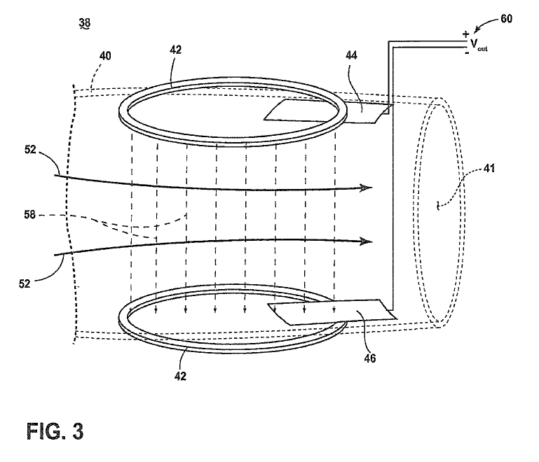

FIG. 3 illustrates the operation of the MHD generator 38 from a perspective view. During operation, the solenoids 42 are energized to generate a magnetic field 58 through the exhaust cavity 41, which will be substantially perpendicular to the exhaust vector 52. As the charged particles entrained in the hot exhaust gases travel along the exhaust vector 52, relative to and/or through the magnetic field 58, the magnetic field 58 respectively attracts or repels the particles toward the respective electrodes 44, 46, and a DC voltage output 60 is generated across the electrode pair 44, 46. In the most basic description, the MHD generator 38 operates by moving a conductor (charged particles of the exhaust) through a magnetic field 58, to generate electrical current from the thermal and kinetic energy of the exhaust gases (collectively, the enthalpy from the exhaust gases). As the amount of current generated is mathematically related to the amount of charged particles in the exhaust gases, additives or ionic materials, such as carbon particles or potassium carbonate may be, for instance, included in the fuel or combustion to increase, decrease, and/or target a particular voltage output 60 for power applications. Additional additives and ionic materials are envisioned. The exhaust gases leaving the exhaust cavity 41 will have a lower temperature, and consequently, a higher gas density, after generating the voltage output 60. The higher gas density results in a higher exhaust gas mass flow rate and, when coupled with the exhaust gas velocity 52, results in an increase in engine propulsion efficiency.

The voltage output 60 may, for instance, provide power to an electrically coupled DC load, the aircraft power system, or may be further coupled with an inverter/converter, which may modify the voltage output 60. Examples of modification of the voltage output 60 may include converting the output 60 to, for example, 270 VDC, or by inverting the output 60 to an AC power output, which may be further supplied to an AC load.

Alternative configurations of the electrodes 44, 46 are envisioned, for instance, where the electrodes 44, 46 are positioned more upstream or downstream of the exhaust section 25. Additional configurations of the electrodes 44, 46 and solenoids 42 are also envisioned such that positive and negative electrode 44, 46 positions are reversed, and/or the solenoids 42 are configured to generate a magnetic field 58 opposite to that shown. Furthermore, while the electrodes 44, 46 are described as generating electrical current via the MHD generator 38, embodiments of the invention may include electrically coupling the electrode pair 44, 46 via an electrical load, such as via powering an electrical component, or via a resistive load, such as an electrical shunt, a diode, or a power dissipation element.

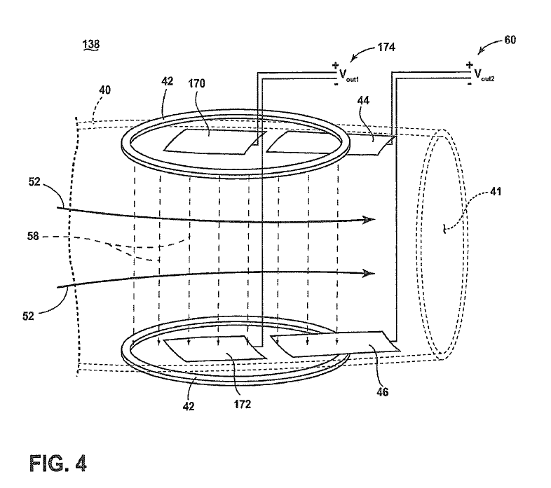

FIG. 4 illustrates an alternative MHD generator 138 according to a second embodiment of the invention. The second embodiment is similar to the first embodiment; therefore, like parts will be identified with like numerals increased by 100, with it being understood that the description of the like parts of the first embodiment applies to the second embodiment, unless otherwise noted. A difference between the first embodiment and the second embodiment is that the MHD generator 138 includes a second set of positive and negative electrodes 170, 172 positioned axially along the exhaust nozzle 40, such that the second pair of electrodes 170, 172 generate a second voltage output 174 during operation of the MHD generator 138. Alternatively, it is envisioned that each electrode pair 44, 46, 170, 172 may be axially offset from each other, and/or may be electrically connected in series to generate a larger, single, voltage output. Additionally, it is envisioned that each electrode pair 44, 46, 170, 172 may have a different physical configuration (e.g. longer, shorter, and/or radial segment) than one or more other electrodes 44, 46, 170, 172. Additional electrode pairs may be included to generate any number of different voltage outputs, as needed.

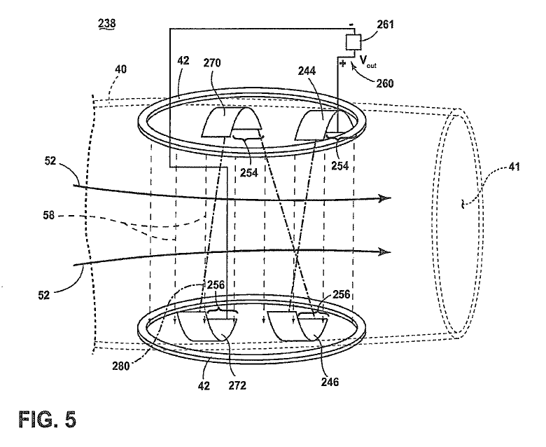

FIG. 5 illustrates an alternative MHD generator 238 according to a third embodiment of the invention. The third embodiment is similar to the first and second embodiments; therefore, like parts will be identified with like numerals increased by 200, with it being understood that the description of the like parts of the first and second embodiments applies to the third embodiment, unless otherwise noted. A difference of the third embodiment is that the positive electrodes 244, 270 of the MHD generator 238 each extend along a larger ring-like portion of a first radial segment 254 of the exhaust nozzle 40 than in the first embodiment, and the negative electrodes 246, 272 each extends along a larger ring-like portion of a second radial segment 256 of the nozzle 40 than in the first embodiment. Another difference of the third embodiment is that the DC voltage output 260 is electrically coupled by a resistive element 261, such as an electrical shunt or diode. Additionally, each of the electrodes 272, 270, 246, 244 are electrically connected in series by conductors 280, which may extend along the inner surface 48, outer surface 50, or integrated with the exhaust nozzle 40, such that the MHD generator 238 generates a single voltage output 260. It is envisioned that each electrode 244, 246, 270, 272 may have a different physical configuration (e.g. longer, shorter, and/or radial segment 254, 256) than one or more other electrodes 244, 246, 270, 272.

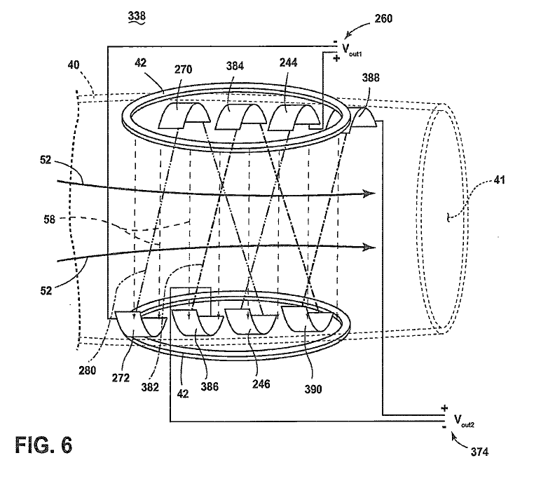

FIG. 6 illustrates an alternative MHD generator 338 according to a fourth embodiment of the invention. The fourth embodiment is similar to the first, second, and third embodiments; therefore, like parts will be identified with like numerals increased by 300, with it being understood that the description of the like parts of the first, second, and third embodiments applies to the fourth embodiment, unless otherwise noted. A difference of the fourth embodiment is that the first set of series-connected electrodes 272, 270, 246, 244 are interweaved with a second set of similar series-connected electrodes 386, 384, 390, 388, connected by a second conductor 382, such that the first set of series-connected electrodes 272, 270, 246, 244 and the second set of series-connected electrodes 386, 384, 390, 388 generate a respective first voltage output 260 and a second voltage output 374.

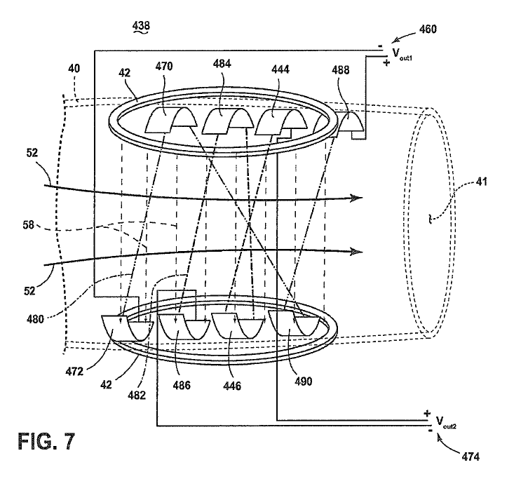

FIG. 7 illustrates an alternative MHD generator 438 according to a fifth embodiment of the invention. The fifth embodiment is similar to the first, second, third, and fourth embodiments; therefore, like parts will be identified with like numerals increased by 400, with it being understood that the description of the like parts of the first, second, third, and fourth embodiments applies to the fifth embodiment, unless otherwise noted. A difference of the fifth embodiment is the alternative series connection of the first set of electrodes 472, 470, 490, 488, coupled via the first conductor 480 and generating a first voltage output 460, and the series connection of the second set of electrodes 486, 484, 446, 444, coupled via the second conductor 482 and generating a second voltage output 474. Another difference of the fifth embodiment is that the second set of electrodes 486, 484, 446, 444 are flanked on either axial end by an electrode pair of the first set of electrodes 472, 470, 490, 488.

Many other possible embodiments and configurations in addition to that shown in the above figures are contemplated by the present disclosure. For example, additional permutations of electrode configurations are envisioned. In another example, one or more of the electrodes, electrode pairs, or electrode rings may be diagonally offset relative to the exhaust vector, or perpendicular to the exhaust vector. Additionally, the design and placement of the various components may be rearranged such that a number of different in-line configurations could be realized.

The embodiments disclosed herein provide a MHD generator integrated with a gas turbine engine. One advantage that may be realized in the above embodiments is that the above described embodiments are capable of generating and/or converting exhaust gas enthalpy into electricity for power electronics. This increases the efficiency of the overall electrical generating efficiency of the turbine engine. Additionally, the increase in electrical generation efficiency may allow for a reduction in weight and size over conventional type aircraft generators. Alternatively, the electricity generation of the MEM generator may provide for redundant electrical power for the aircraft, improving the aircraft power system reliability.

Another advantage that may be realized in the above embodiments is that the conversion of the exhaust gas enthalpy into electricity lowers the exhaust gas temperature, which increases the exhaust gas density. The increase gas density results in an increase in momentum, and thus, an increase in the propulsion efficiency of the gas turbine engine. An increase in the propulsion efficiency may result in improved operating or fuel efficiency for the aircraft.

In addition, a gain in propulsion efficiency can be realized when ions are entrained into the exhaust gas. As ions are allowed to flow into the exhaust gas plume, the mass of the plume increases. Thereby, allowing for an increase in momentum. Furthermore, if the ions are stored in a tank on-board the aircraft, these ions are at a significantly lower temperature than the exhaust gas plume and further drive the gas plume temperature down; thereby decreasing the plume temperature through a mixing affect. A lower gas temperature again results in an increase in plume density; thereby further increasing the plume mass and the aircraft propulsion efficiency.

Control electronics may be integrated into the DC electronic chassis using a Proportional Integral Differential (PID) Controller to control the DC power generation as a function of power requirement by controlling the valve that allows the flow from positive and negative ions from being entrained into the engine exhaust plume. The flow control is also a means of increasing the propulsion efficiency when needed.

When designing aircraft components, important factors to address are size, weight, and reliability. The above described MHD generators will be able to provide regulated AC or DC outputs with minimal power conversion equipment, making the complete system inherently more reliable. This results in a lower weight, smaller sized, increased performance, and increased reliability system. Reduced weight and size correlate to competitive advantages during flight.

To the extent not already described, the different features and structures of the various embodiments may be used in combination with each other as desired. That one feature may not be illustrated in all of the embodiments is not meant to be construed that it may not be, but is done for brevity of description. Thus, the various features of the different embodiments may be mixed and matched as desired to form new embodiments, whether or not the new embodiments are expressly described. All combinations or permutations of features described herein are covered by this disclosure. The primary differences among the exemplary embodiments relate to the configuration of the electrode pairs, and these features may be combined in any suitable manner to modify the above described embodiments and create other embodiments.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An exhaust section for an aircraft gas turbine engine, comprising:
an exhaust nozzle in a downstream serial flow relationship with the gas turbine engine, and defining an exhaust cavity through which combustion exhaust gases of the engine are emitted in a direction defining an exhaust vector; and
a magnetohydrodynamic (MHD) generator having a magnetic field generator forming a magnetic field having at least some magnetic field lines perpendicular to the exhaust vector, and at least one electrically coupled electrode pair, comprising at least one positive electrode and at least one negative electrode, arranged relative to the exhaust cavity wherein movement of charged particles entrained in the exhaust gas along the exhaust vector generates current between the at least one electrode pair;
wherein the conversion of exhaust gas enthalpy into electric current by the MHD generator increases the propulsion efficiency of the gas turbine engine by reducing the exhaust gas temperature.

2. The exhaust section of claim 1 further comprising a charged particle reservoir fluidly coupled to the exhaust nozzle.

3. The exhaust section of claim 2 wherein the charged particle reservoir comprises a nozzle having an inlet fluidly coupled to the reservoir and an outlet fluidly coupled to the exhaust nozzle.

4. The exhaust section of claim 3 wherein the outlet further comprises at least one of a spray nozzle or ring disposed on an inner surface of the exhaust nozzle configured to entrain charged particles in the exhaust gas.

5. The exhaust section of claim 2 wherein the charged particles comprise at least one of carbon particles or potassium carbonate.

6. The exhaust section of claim 2 further comprising a valve fluidly coupled with the reservoir to control the flow of the charged particles to the exhaust nozzle.

7. The exhaust section of claim 1 wherein the exhaust nozzle is in a downstream serial flow relationship with the internal engine exhaust plume.

8. The exhaust section of claim 1 wherein the magnetic field generator further comprises at least one solenoid configured to generate the magnetic field.

9. The exhaust section of claim 1 wherein the at least one electrode pair is diagonally offset relative to the exhaust vector.

10. The exhaust section of claim 1 wherein the at least one electrode pair is axially spaced relative to the exhaust vector.

11. The exhaust section of claim 10 wherein the at least one positive electrode and the at least one negative electrode are located oppositely to each other relative to the exhaust cavity.

12. The exhaust section of claim 10 comprising multiple electrode pairs.

13. The exhaust section of claim 10 wherein the at least one positive electrode comprises at least at least one partial positive electrode ring extending along a first radial segment along the exhaust section and the at least one negative electrode comprises at least one partial negative electrode ring extending along a second radial segment along the exhaust section, and wherein the at least one positive electrode ring and the at least one negative electrode ring define an electrode ring pair.

14. The exhaust section of claim 1 wherein the exhaust section further comprises an inner surface and an outer surface and the at least one electrode pair is supported on at least one of the inner surface or the outer surface.

15. The exhaust section of claim 1 wherein the electrode pair are electrically coupled by at least one of a resistive element, an electrical shunt, a diode, or a power dissipation element.
